(19) United States
(12) Patent Application Publication
(10) Pub. No.: US 2017/0053307 A1
(43) Pub. Date: Feb. 23, 2017

(54) TECHNIQUES FOR DETECTING AND VERIFYING FRAUDULENT IMPRESSIONS

(71) Applicant: SIZMEK TECHNOLOGIES LTD., Herzliya (IL)

(72) Inventors: Jonathan SCHLER, Petach Tikwa (IL); Kobi SHEMER, Netanya (IL)

(73) Assignee: SIZMEK TECHNOLOGIES LTD., Herzliya (IL)

(21) Appl. No.: 14/830,207

(22) Filed: Aug. 19, 2015

(51) Int. Cl. G06Q 30/02

(52) U.S. Cl. CPC G06Q 30/0248

(57) ABSTRACT

A system and method for verifying ad-impressions of online advertisements are provided. The method includes receive an ad-impression; determining an impression source of the received ad-impression; comparing the determined impression source to a non-advertisement-serving web-source (NASW) list, wherein the NASW list contains at least one web-source that does not display online advertisements; determining whether the impression source matches a web-source listed in the NASW list; and upon determining a match, identifying the received ad-impression as fraudulent.

### TECHNICAL FIELD

The present disclosure relates generally to impressions for advertising systems, and more specifically to preventing fraudulent impressions.

### BACKGROUND

Websites, including commercial, corporate, and personal websites, publish advertisements on their webpages. Such advertisements are typically published in the form of banners that may be comprised of static or rich media content. Banners that include rich media content are displayed as a combination of text, audio, still images, animation, video, and interactivity content for forms.

Advertisement (Ad) serving relates to the placement of advertisements on webpages and/or within multimedia content. In addition to placing advertisements, advertisement serving systems also select which advertisements should be served to websites based on advertising campaign preferences, count impressions, click counts on advertisements, and monitored progress of different advertising campaigns. An advertisement serving system is typically realized as a server backed by a database server that stores advertisements.

Typically, selection of which ads to serve on which webpages is determined through an auction process. In such a process, advertisers bid for allocation and serving of their online advertisements in connection with serving opportunities. In online advertising, an auction process is typically realized by means of real-time bidding (RTB) system.

A RTB system is the means for buying and selling an advertising inventory on a per-impression basis. A RTB system allows advertising buyers to bid on an impression and, if the bid is won, the buyer's advertisement is instantly displayed on a publisher's website. Real-time bidding is distinguishable from static auctions by how it is a per-impression way of bidding, whereas static auctions are groups of up to several thousand impressions.

FIG. 1 shows an exemplary and non-limiting schematic diagram of a computer system 100 illustrating a typical advertisement serving process. A user device 120, an advertisement-serving (ad-serving) system 130, a web server 140, and a RTB server 160 are communicatively connected to a network 110. The network 110 is typically the World Wide Web (WWW).

The web server 140 is often referred to as a publisher hosting website accessible by the user device 120. The webpages provided by the web server 140 may include advertisements served by the ad-serving system 130. In a typical deployment, a webpage downloaded from a web server 140 includes a piece of code that calls for the ad-serving system 130 to place an advertisement in the webpage.

A typical transaction begins with a user of a user device 120 visiting a website hosted by the server 140. The ad-serving system 130, upon receiving a call from the web-server 140, may trigger a bid request for an ad-impression that includes at least a domain name of the visited request. The ad-impression is sent to advertisers 170 that automatically submit, through the RTB server 160, bids in real time to place their ads. Advertisers 170 bid on each ad-impression as it is served.

Typically, the impression (i.e. advertisement placement) is granted to the highest bidder and their advertisement is served, by the ad-serving system 130, on the webpage visited by the user of the user device 120. The ad-serving system 130 handles multiple campaigns, and each campaign may include multiple advertisements to be served at different webpages. The bidding process is performed per ad-impression per advertisement slot on a webpage. Thus, the real-time bidding process is an automated process. The advertisers 170 autonomously bid based on an ad-impression based on a set of predefined criteria mostly tied to monetary parameters, such as budget and a price range. As such, advertisers 170 and their agents do not and cannot check the validity of each ad-impression to be served.

Some entities have begun taking advantage of this inefficient monitoring by falsifying ad-impressions submitted to the RTB server 160. A fraudulent ad-impression attempts to serve an advertisement in a website that typically does not display ads. Examples for non-advertisement-serving websites are: “.gov”, “.org”, and “.edu” websites, and the like. The falsification of ad-impression is typically performed to maximize bids, which is usually based on “quality” of impression.

For many reasons, an advertising agency may demonstrate a significant interest to place advertisements in such non-advertisement-serving websites, as such websites are typically creditable and draw targeted traffic. For example, it would be highly beneficial to place an advertisement for an IP Law Firm on the USPTO.GOV website. Thus, an advertising agency would place a higher bid on such an ad-impression.

Although fraudulent ad-impressions can appear legitimate, they do not represent actual impressions. Thus, serving and bidding fraudulent ad-impressions results in wasting a campaign's budget and resources on advertisements that are not actually shown to viewers.

In addition, falsifying impressions can also be related to impression counts received after the ads have been served. Falsifying impression counts increases their apparent numbers of views from non-advertisement-serving websites. Although such impression counts can appear legitimate, they do not represent actual impressions. Such fraudulent impression counts waste a company's money and resources on advertisements that are not actually shown to viewers.

It would therefore be advantageous to provide a solution that would prevent advertisers from bidding on fraudulent ad-impressions. It would be further advantageous if such a solution could verify impression counts before, after, and/or during an advertising campaign.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” may be used herein to refer to a single embodiment or multiple embodiments of the disclosure.

Certain exemplary embodiments include a method and system for verifying ad-impressions of online advertisements. The system comprises receiving an ad-impression; determining an impression source of the received ad-impression; comparing the determined impression source to a non-advertisement-serving web-source (NASW) list, wherein the NASW list contains at least one web-source that does not display online advertisements; determining whether the impression source matches a web-source listed in the NASW list; and upon determining a match, identifying the received ad-impression as fraudulent.

Certain exemplary embodiments include a method and system for verifying impression counts of online advertisements. The method comprises receiving ad-serving data including at least an impression count and an impression source for an online advertisement; comparing the impression source to a non-advertisement-serving web-source (NASW) list, wherein the NASW list contains at least one web-source that does not display online advertisements; determining whether the impression source matches a web-source listed in the NASW list; and upon determining a match, identifying the impression count of the online advertisement as fraudulent.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a diagram illustrating a conventional serving system.

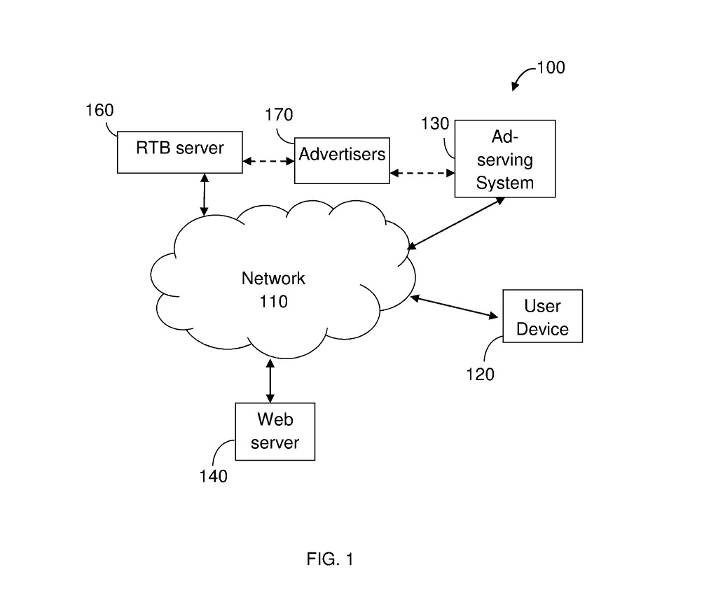

FIG. 2 is a diagram of a networked system utilized to describe the various embodiments.

FIG. 3 is a schematic diagram of a structure of a NASW list.

FIG. 4 is a flowchart illustrating a method for pre-bidding verification of ad-impressions according to one embodiment.

FIG. 5 is a flowchart illustrating method for post-serving verification of impression counts according to one embodiment.

FIG. 6 a flowchart illustrating blocking a source of fraudulent ad-impressions based on identification of a plurality of fraudulent ad-impressions according to an embodiment

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

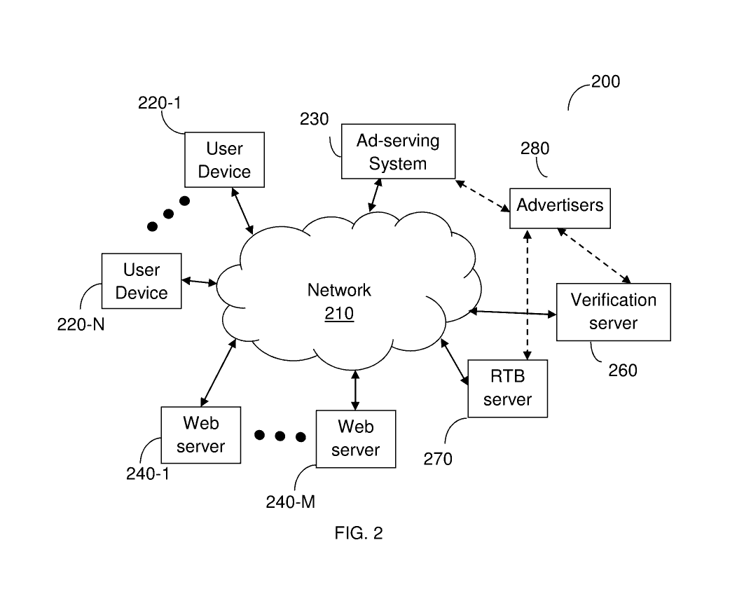

FIG. 2 shows an exemplary and non-limiting schematic diagram of a networked system 200 utilized to describe the disclosed various embodiments. User devices 220-1 through 220-N (hereinafter referred to collectively as user devices 220 and individually as a user device 220), an advertisement-serving (ad-serving) system 230, web servers 240-1 through 240-M (hereinafter referred to collectively as web servers 240 or individually as a web server 240), a verification server 260, and a RTB server 270 are communicatively connected to a network 210. The network 210 is typically the World Wide Web (WWW). Also included in the system 200 are advertisers 280-1 through 280-R (hereinafter referred to collectively as advertisers 280 and individually as an advertiser 280), communicatively connected to the ad-serving system 230, the verification server 260, and the RTB server 270. The communication with the advertisers 280 is either through the network 210 or through a direct connection.

An advertiser 280 is a computing device operated by an advertising agency to place bids on ad-impressions and provide the ad-serving system 230 with advertisements to be served. A user device 220 may be, for example, a personal computer (PC), a personal digital assistant (PDA), a mobile phone, a smart phone, a tablet computer, a laptop, and the like, having capabilities for downloading and displaying webpages. The web servers 240 are often referred to as publishers host websites accessible through the user devices 220.

In a typical deployment, a webpage downloaded by any user device 220 from a web server 240 includes a piece of code that calls for the ad-serving system 230 to place an advertisement in the webpage. When a request to place a call is received at the ad-serving system 230, a bid request on an ad-impression is triggered. The bid request includes at least a domain name of the website accessed by the user device 220. The ad-serving system 230 may also include, in the bid request, accompanying data such as the user demographic information, browsing history, location, and the webpage being loaded. The ad-serving system 230 is configured to send the bid request on the ad-impressions to all or some of the advertisers 280. In response, the RTB server 270 selects the highest bids among the bids received from the different advertisers 280. Thereafter, the ad-serving system 230 serves the ad-impression with an advertisement received from the winning advertiser 280.

According to the disclosed embodiments, impression verification processes for detecting fraudulent ad-impressions and fraudulent ad-impression counts are disclosed. In an embodiment, the former is performed prior to bidding (and hence serving) on an ad-impression, while the latter is performed post serving. In both verification processes, it is checked if the impressions are of non-advertisement-serving websites. A non-advertisement-serving website is website that typically does not host advertisements. Examples for such websites include “.gov”, “.org”, “.edu” websites, and the like. In an embodiment, the impression verification processes are performed by the verification server 260.

For the verification purposes, the verification server 260 is configured to generate a list of non-advertisement-serving websites (hereinafter the “NASW list”). The NASW list specifies all web sources that do not display advertisements. For example, advertisements are for commercial merchandise or services. In an embodiment, the webpages or websites listed in the NASW list is are generated based on the content of non-advertisement-serving websites rather than by, e.g., domain suffix (e.g., .mil, .edu, etc.). As a result, the non-advertisement-serving websites in the NASW list are not limited by domain, country, or language.

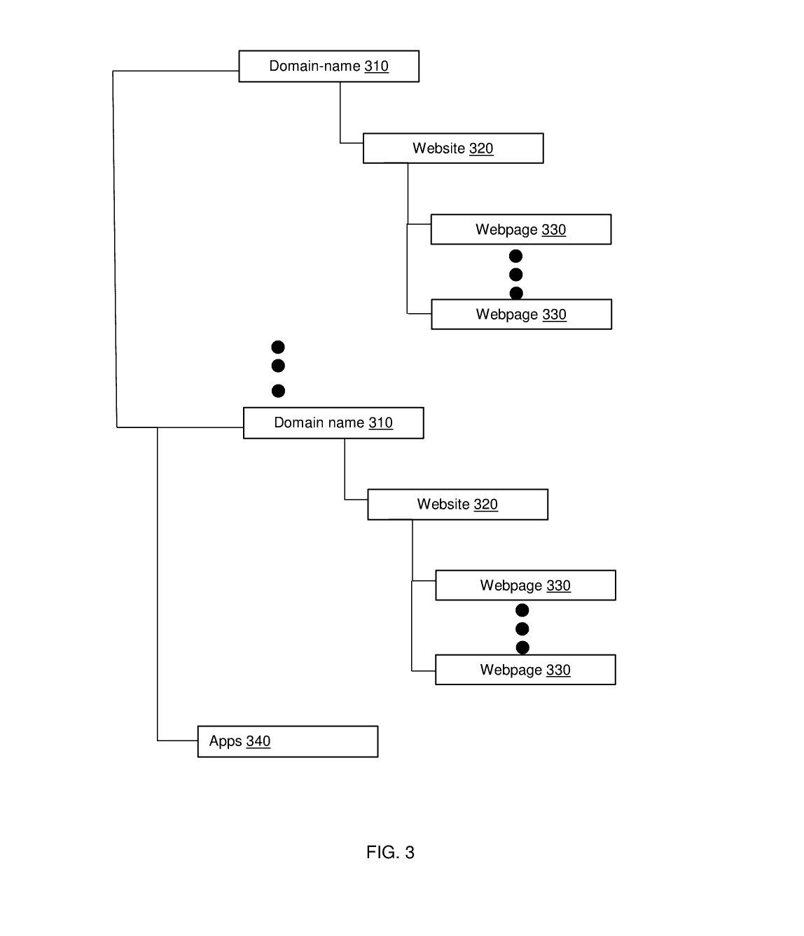

As illustrated in the exemplary and non-limiting FIG. 3, the NASW list 300 is a tree structure including domain names 310, one or more websites 320 in each respective domain name 310, and one or more webpages 330 in each of the websites 320. The NASW list 300 may also include one or more applications (apps) 340. The apps 340 may be part of or separated from the tree structure illustrated in FIG. 3. The domain names 310 may be sorted by their suffix indicating a top level domain.

All the web sources (310 through 340) designated in the NASW list 300 do not include any online advertisements that are typically served by ad-serving systems. Typically, operators of such resources either do not allow or block access by an ad-serving system to serve advertisements. As an example, a domain name 310 may be uspto.gov, a respective website 320 may be the URL www.uspto.gov, while webpages 330 may be designated by their respective suffix, e.g., /patents, /patents-getting-started/patent-process-overview, and so on.

It should be noted that, in some cases, the domain names 310 and their respective websites 320 may be the same. Other examples for domain names 310 are domain names having any of the following suffixes and/or classifications: “.gov” for government agencies, “.edu” for educational institutions, “.org” for organizations, “.mil” for military, secured websites (such as banks), and the like. It should be noted that, in some cases, certain webpages under non-advertisement-serving websites may include advertisements. In such cases, the NASW list 300 designates only webpages under their respective website that do not display and advertisements. The apps 350 listed in the NASW list 300 are apps that do not display advertisements from external sources.

Returning to FIG. 2, in an embodiment, the verification server 260 is configured to generate the NASW list 300 by crawling through the plurality of web servers 240 and through the network 210. The verification server 260 is further configured to analyze each web server 240 encountered during the crawling process to determine if the source is considered as non-advertisement-serving. Each such source identity is saved in the NASW list 300.

The crawling can be performed using standard web crawling techniques. Typically, a web crawling process starts with one or more seed URLs. In an embodiment, a seed URL may be of a website known to be a non-advertisement-serving website. As the process initially visits the seed URLs, the process identifies all the hyperlinks in the webpage and adds them to the list of URLs to visit in a crawl frontier. URLs from the frontier are recursively visited. The list of URLs of respective of webpages encountered during the web crawling is saved in a crawler list. The crawling process can be repeated at predefined time intervals.

In an embodiment, to optimize the crawling process, the crawler (part of the verification server 260) is provided with a list of URLs that are known (and verified) to include advertisements, and the crawler is instructed to skip any URL in the list of URLs. This list of URLs may be provided by the ad-serving system 230 based on advertisements served.

The verification server 260 is further configured to analyze each webpage whose respective URL is designated in the crawler list to determine if such a webpage displays, or is coded to display, an advertisement. In an embodiment, the analysis performed by the verification server 260 includes scanning each webpage to detect a piece code indicating a potential placement of an advertisement or call for a placement of an advertisement. For example, the verification server 260 attempts to identify a call for an ad-serving system, a tag to place a banner, a tag to detect user interaction with the webpage, scripts that call for pop-up pages/banners, any combination thereof, and so on. The pieces of codes may be in a HTML, a JavaScript or any programming language used for developing webpages. The analysis may be respective of certain content attributes, such as a layout of a webpage, a font size, color, embedded objects, and so on.

Each webpage determined not to include any advertisement placement is saved together with its respective website in the NASW list 300. For example, if the webpage www.example.com/exmp1 is determined not to include any advertisement placement, then the URL www.example.com is added as a website 320, and “/exmp1” is added as the respective webpage 330. The analysis of webpages designated in the crawler list is repeated every predefined time interval and/or when the crawler list is updated. Therefore, the analysis of webpage encountered during the search may results in non-advertisement-serving websites that are not based merely on their domain suffix.

In another embodiment, once the analysis of webpages listed in the crawler list is completed, the contents of the generated NASW list 300 can be cross-correlated with a list of URLs that are known (and verified) to include advertisements. This process removes from the NASW list 300 any URLs included in both lists.

According to some embodiments, the verification sever 260 is configured to perform a pre-bidding verification process on each ad-impression. To this end, the verification server 260 is configured to receive an ad-impression (respective of a bid request) from the ad-serving system 230 and check if the ad-impression is fraudulent. Specifically, the check includes comparing a URL of the ad-impression against the contents of the NASW list 300. If a match exists, then the ad-impression is determined to be fraudulent.

Upon identification of a fraudulent ad-impression, a message is sent to the advertisers 280 to ignore the respective bid request. Additionally, the message is sent to the ad-serving system 230 to block any future ad-serving requests from the fraudulent URL and/or its domain name. In an embodiment, the fraudulent URLs may be kept in a “black list” in the ad-serving system 230.

According to another embodiment, the verification sever 260 is configured to perform a post-serving verification process on impression counts. Such verification may be performed per campaign for each advertisement of a campaign served by the ad-serving system 230. In this embodiment, for each served advertisement, the ad-serving system 230 is configured to collect data respective of the served advertisement via execution of the script. Such data will be referred to hereinafter as “ad-serving data,” and includes, for example, URLs of the webpages in which advertisements are placed, domain names of the pages' websites, and impression counts. The ad-serving data may further include geographic information of users of devices who access the URLs and websites, the time when each URL was accessed, data that was accessed, a unique identifier of a user device 220 that viewed the advertisement, and so on.

The ad-serving data is typically collected over a predefined period of time (e.g., one month, one day, one hour, and so on). It should be noted that the ad-serving data may be collected for many different campaigns over a large number of websites in which the campaigns run. Therefore, the ad-serving data may include an extensive list of URLs (e.g., millions of records) visited by a large number of users through user devices 220 over a certain period of time.

In an embodiment, the collected ad-serving data is analyzed to determine if the impression count accounted for fraudulent URLs. Specifically, at least one of URLs of the webpages in which advertisements are placed, and/or domain names of the webpages' websites in the ad-serving data, are compared against the contents of the NASW list 300. If a match exists, then the impression count is determined to be fraudulent. For example, if the ad-serving data includes a URL (www.uspto.gov), then an advertisement has allegedly been served to at this page. The impression count provided in the ad-serving data is 100,000, which signifies that 100,000 viewers have allegedly viewed the ad. Because the URL (www.uspto.gov) is a non-advertisement-serving website and would be included in the ANSW list 300, the impression count is determined to be fraudulent.

In one implementation, the verification server 260 includes a processing system communicatively connected to a memory (processing system and memory not shown). In one implementation, the memory contains instructions that, when executed by the processing system, results in the performance of, but not limited to, the pre-bidding and post-serving verification processes.

The processing system may include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing system to perform the various functions described herein. In one configuration, the processing system may include one or more processors. The one or more processors may be implemented with any combination of general-purpose microprocessors, multi-core processors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

It should be noted that various embodiments have been described herein with a specific reference that the verification sever 260 is a separate entity from the ad-serving system 230. However, in some implementations, the functionality of the verification sever 260 may be integrated in the ad-serving system 230.

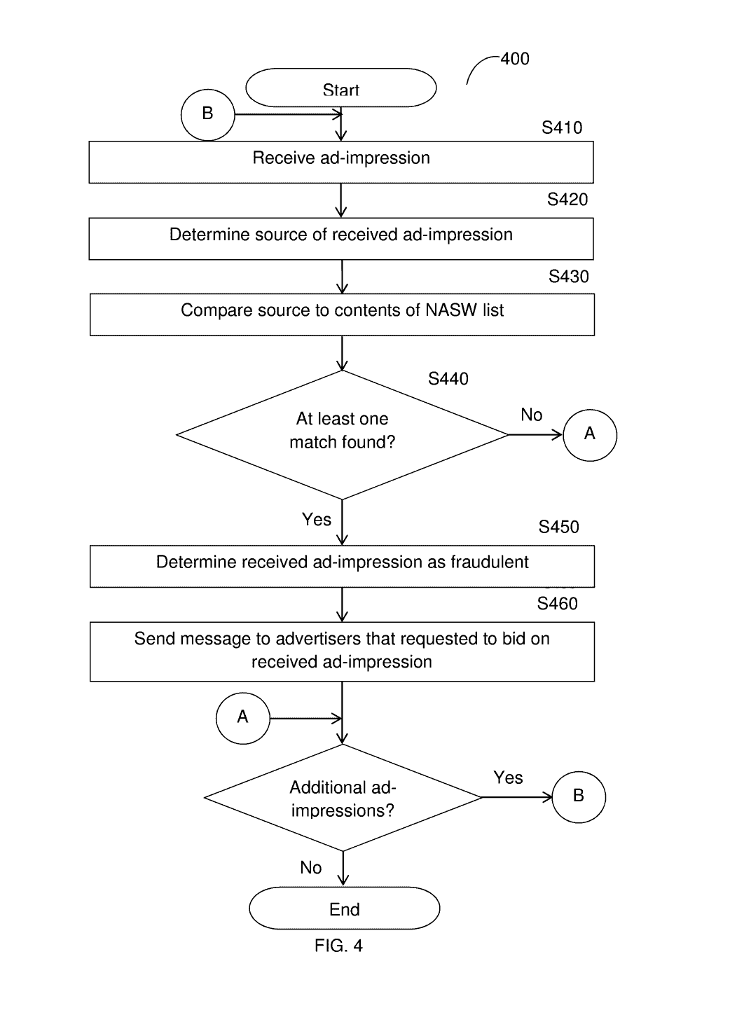

FIG. 4 is an exemplary and non-limiting flowchart 400 illustrating a method for pre-bidding verification of ad-impressions according to one embodiment. At S410, an ad-impression is received. The ad-impression is received in a response to a bid request for serving an online advertisement. As noted above, the ad-impression designates at least a web source (e.g., a webpage) where an advertisement should be placed and served.

At S420, the source of the received ad-impression is determined. The source may be a URL or any networking address designating, for example, a webpage, a website, a domain name, an application, and the like. At S430, the determined source of the ad-impression is compared against the contents of a NASW list. In one implementation, the NASW list includes all web sources that do not display online ads. For examples, ads are for commercial merchandise or services. Exemplary embodiments for generation of NASW lists is described further herein above with respect to FIGS. 2 and 3.

In S440, it is checked if at least one match is found between the determined source and the NASW list, and if so execution continues with S450; otherwise, execution continues with S470. At S450, the received ad-impression is determined as fraudulent. False impression sources are webpages, domain names, and/or apps that do not display advertisements. Any ad-impression that purports to be received from such a false impression source is fraudulent. At S460, if the received ad-impression is fraudulent, a message is sent to advertisers that requested to bid on the received ad-impression. The message typically indicates that the ad-impression is false and should be ignored. A message can be also sent to the ad-serving server to block any of the triggering of false bid requests received from the fraudulent ad-impression. Additionally, the message on a fraudulent ad-impression may be sent to a RTB system to block or otherwise ignore any bids received on the respective ad-impression. In an embodiment, when bid requests have already been placed, such requests may be subject to further scrutiny to determine, for example, whether the advertisement should be served.

At S470, it is checked if additional ad-impressions to be verified have been received and, if so, execution continues with S410; otherwise, execution terminates.

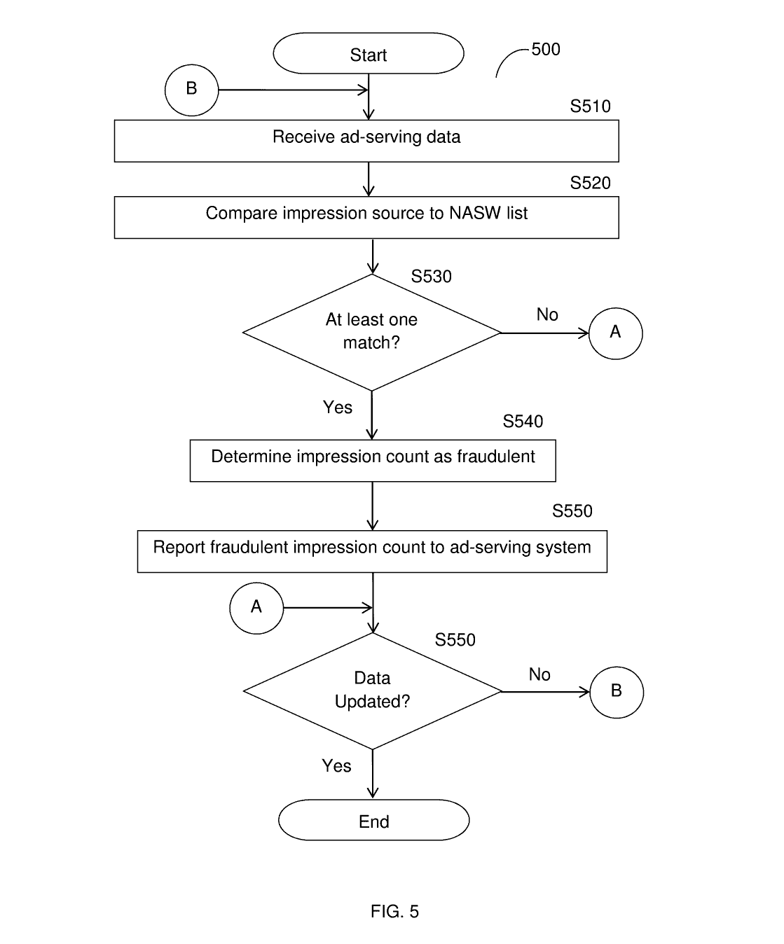

FIG. 5 is an exemplary and non-limiting flowchart 500 illustrating a method for post-serving verification of impression counts according to one embodiment. At S510, ad-serving data is received. Such data is typically collected by an ad-serving system and includes at least an impression source where an online ad was placed and the impression count of the advertisement. The impression source may be, for example, a URL of a domain name, website, and/or web page in which the advertisement is placed. The impression count may include, but is not limited to, a number or other measures of impressions.

At S520, the impression source designated in the received data is compared to the contents of the NASW list. At S530, it is checked if at least one match is found between the determined source and the NASW list and, if so, execution continues with SS40; otherwise, execution continues with S560.

At SS40, the impression count that was determined to be fraudulent as impressions are originated from a false source. At S550, the fraudulent impression count is reported to the ad-serving system. At S560, it is checked if ad-serving data have been updated and, if so, execution returns to S510; otherwise, execution ends.

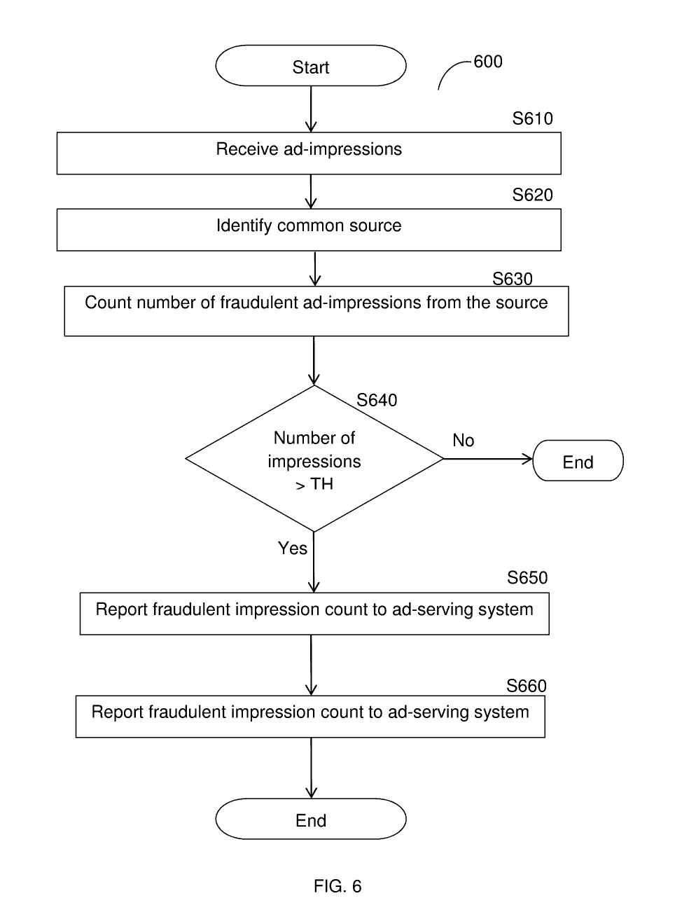

FIG. 6 is an exemplary and non-limiting flowchart 600 illustrating blocking a source of fraudulent ad-impressions based on identification of a plurality of fraudulent ad-impressions according to an embodiment. At S610, a plurality of ad-impressions is identified as fraudulent. At S620, at least one source that is common to two or more of the grouped fraudulent ad-impressions is determined.

At S630, for each of the at least one common source, the number of fraudulent ad-impressions of the plurality of fraudulent ad-impressions associated with each source is determined. At S640, each number is compared to a predetermined fraudulent source threshold. The predetermined fraudulent source threshold is a minimum requirement for identifying a common source as a source of fraudulent ad-impressions and may be, but is not limited to, a number of ad-impressions. At S650, each common source that is associated with a number that exceeded the fraudulent source threshold is identified as a fraudulent source. At S660, each identified fraudulent source may be blocked or otherwise ignored.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for verifying ad-impressions of online advertisements, comprising:
receiving an ad-impression;
determining an impression source of the received ad-impression;
comparing the determined impression source to a non-advertisement-serving web-source (NASW) list, wherein the NASW list contains at least one web-source that does not display online advertisements;
determining whether the impression source matches a web-source listed in the NASW list; and
upon determining a match, identifying the received ad-impression as fraudulent.

2. The method of claim 1, wherein the ad-impression is received in response to real-time bidding requests on the ad-impression.

3. The method of claim 2, further comprising:
reporting the fraudulent ad-impression to the advertisers to prevent placement of real-time bids on the ad-impression.

4. The method of claim 1, wherein the impression source is a networking address of any one of: a domain name, a website, a webpage, and an application.

5. The method of claim 1, further comprising:
generating the NASW list to include web-sources that do not display online advertisements.

6. The method of claim 5, wherein the web-source includes at least one of: a domain name, a website a webpage, and an application.

7. The method of claim 5, further comprising:
crawling through a plurality of web sources connected in a network;
for each web source of the plurality web sources encountered during the crawl, analyzing the web source to determine if the web source contains a piece of code indicating a placement of an advertisement; and
adding, to the NAWS list, each web source that does not contain the piece of code indicating a placement of an advertisement.

8. The method of claim 1, further comprising:
blocking a source generating the identified fraudulent ad-impression.

9. The method of claim 8, further comprising:
identifying a common source of a plurality of different identified fraudulent ad-impressions; and
blocking the common source generating the plurality of identified fraudulent ad-impressions, upon determining that a number of the plurality of identified fraudulent ad-impressions crosses a fraudulent source.

10. A non-transitory computer readable medium having stored thereon instructions for causing one or more processing units to execute the method according to claim 1.

11. A method for verifying impression counts of online advertisements, comprising:
receiving ad-serving data including at least an impression count and an impression source for an online advertisement;
comparing the impression source to a non-advertisement-serving web-source (NASW) list, wherein the NASW list contains at least one web-source that does not display online advertisements;
determining whether the impression source matches a web-source listed in the NASW list; and
upon determining a match, identifying the impression count of the online advertisement as fraudulent.

12. The method of claim 11, wherein the impression source is a networking address of any of: a domain name, a website, a webpage, and an application.

13. The method of claim 11, further comprising:
generating the NASW list to include web-sources that do not display online advertisements.

14. The method of claim 13, wherein the web-source includes at least one of: a domain name, a website, a webpage, and an application.

15. The method of claim 13, further comprising:
crawling through a plurality of web sources connected in a network;
for each web source of the plurality of web sources encountered during the crawl, analyzing the web source to determine if the web source contains a piece of code indicating on a placement of an advertisement; and
adding, to the NAWS list, each web source that does not contain the piece of code indicating on a placement of an advertisement.

16. A non-transitory computer readable medium having stored thereon instructions for causing one or more processing units to execute the method according to claim 13.

17. A system for eliminating fraudulent impressions in online advertisements, comprising:
a processing unit; and
a memory, the memory containing instructions that, when executed by the processing unit, configure the system to:
receive an ad-impression;
determine an impression source of the received ad-impression;
compare the determined impression source to a non-advertisement-serving web-source (NASW) list, wherein the NASW list contains at least one web-source that does not display online advertisements;
determine whether the impression source matches a web-source listed in the NASW list; and
upon determining a match, identify the received ad-impression as fraudulent.

18. The system of claim 17, wherein the ad-impression is received in response to real-time bidding requests on the ad-impression.

19. The system of claim 17, wherein the system is further configured to:
report the fraudulent ad-impression to the advertisers to prevent placement of real-time bids on the ad-impression.

20. The system of claim 17, wherein the system is further configured to:
generating the NASW list to include web-sources that do not display online advertisements.

21. The system of claim 17, wherein the system is further configured to:
crawl through a plurality of web sources connected in a network;
for each web source of the plurality web sources encountered during the crawl, analyze the web source to determine if the web source contains a piece of code indicating a placement of an advertisement; and
add to the NAWS list, each web source that does not contain the piece of code indicating a placement of an advertisement.

22. The system of claim 17, wherein the system is further configured to:
block a source generating the identified fraudulent ad-impression.

23. The system of claim 22, wherein the system is further configured to:
identifying a common source of a plurality of different identified fraudulent ad-impressions; and
blocking the common source generating the plurality of identified fraudulent ad-impressions, upon determining that a number of the plurality of identified fraudulent ad-impressions crosses a fraudulent source.

24. A system for verifying impression counts of online advertisements, comprising:
a processing unit; and
a memory, the memory containing instructions that, when executed by the processing unit, configure the system to:
receive ad-serving data including at least an impression count and an impression source for an online advertisement;
compare the impression source to a non-advertisement-serving web-source (NASW) list, wherein the NASW list contains at least one web-source that does not display online advertisements;
determine whether the impression source matches a web-source listed in the NASW list; and
upon determining a match, identify the impression count of the online advertisement as fraudulent.

25. The system of claim 24, wherein the system is further configured to:
generate the NASW list to include web-sources that do not display online advertisements.

26. The system of claim 24, wherein the system is further configured to:
crawl through a plurality of web sources connected in a network;
for each web source of the plurality of web sources encountered during the crawl, analyze the web source to determine if the web source contains a piece of code indicating on a placement of an advertisement; and
add, to the NAWS list, each web source that does not contain the piece of code indicating on a placement of an advertisement.

27. The method of claim 24, wherein the web-source includes at least one of: a domain name, a website, a webpage, and an application.
